(19) United States
(12) Patent Application Publication
(10) Pub. No.: US 2008/0223468 A1
(43) Pub. Date: Sep. 18, 2008

(54) Storage mechanism for use within recreational vehicles

(76) Inventor: Lannie Stegall, Lexington, KY (US)

Correspondence Address: STOCKWELL & SMEDLEY, PSC, 861 CORPORATE DRIVE, SUITE 200, LEXINGTON, KY, 40503, US

(21) Appl. No.: 11/724,433

(22) Filed: Mar. 15, 2007

(51) Int. Cl. B60P 3/22

(52) U.S. Cl. 137/899

(57) ABSTRACT

A storage mechanism for managing the hoses used within the service bay of recreational vehicles (RVs) is disclosed. The storage mechanism increases accessibility to various parts within the service bay area, and also reduces safety risk associated with emptying the wastewater compartments commonly found in RVs.

### FIELD OF THE INVENTION

The present invention relates to hoses connected to wastewater compartments of recreational vehicles (RVs), and more particularly to a storage mechanism for use therein.

### BACKGROUND OF THE INVENTION

Most RVs have a black water and gray water waste tanks. The black tank is for sewage, while the gray tank is for shower and sink. Emptying and maintaining these tanks requires specialized hoses. However, it is desired to minimize a user's handling of theses hoses. Consequently, an improved mechanism for managing these hoses is desired.

### SUMMARY OF THE INVENTION

It is the object of this invention to provide a housing for the various hoses that are a part of the storage tanks in an RV. It is another object of this invention for that housing to contribute to accessibility and ease of use of the various devices within an access bay of that RV. These and other objects and advantages of the invention will become readily apparent as the following description is read in conjunction with the accompanying drawings.

### BRIEF DESCRIPTION OF THE DRAWINGS

FIG. 1 shows prior art;

FIG. 2 shows an exemplary embodiment of the present invention;

FIG. 3A is a schematic arrangement of a portion of the present invention;

FIG. 3B show an additional portion of the present invention implemented within the scheme of FIG. 3A;

FIG. 4A shows an RV, and FIG. 4B shows the embodiment of FIGS. 2 and 3 implemented within the RV of FIG. 4A;

FIG. 5 shows an exemplary embodiment of the PI;

FIG. 6A shows exemplary features of the embodiment shown in FIG. 4;

FIGS. 6B and 6C show additional features of the embodiment shown in FIG. 6A; and

FIGS. 7 and 8 show additional features of the present invention.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

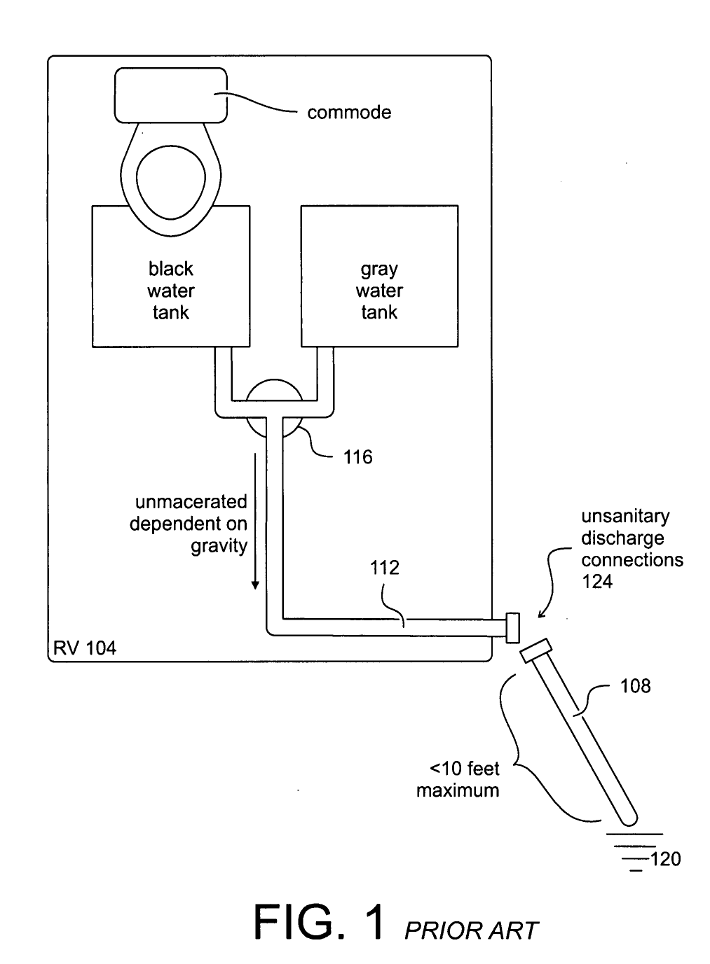

As shown in FIG. 1, both black and grey holding tanks are fitted directly onto a typical RV 104. FIG. I shows that the black tank is usually located directly below the toilet area, so that the waste will fall directly into the tank when the toilet is flushed. The only entry into the black tank that is not direct spill is waste that has gone through a toilet with a macerator pump (not shown) mounted into the drain of the commode. This is an unusual arrangement, seldom found in RVs, and is also not very practical.

Also as shown in FIG. 1, for the purposes of space utilization, the black and gray tanks are mounted side by side, over a fresh water tank (not shown). The stored fresh water for use in the RV is typically double the size of an individual tank. Thus, the combination of the black and gray tanks total volume will be approximately equal to the fresh water tank's total volume.

Certain details of FIG. 1 are abbreviated for clarity. However, it is well known in the RV universe that the plumbing from the black and gray tanks to the discharge connections 124 is routed through small openings, and is difficult to maintain and almost impossible to repair unless all tanks are entirely removed. This makes repair very expensive and difficult to do safely.

To clean a black tank, for example, a tank flushing head (not shown) can be mounted into the tank to spray fresh water under pressure to remove the solids that collect on the walls of the tank. This exposure to the open air when the water level in the black tank is low allows odors to be produced and vented to the atmosphere. These odors can also be pushed into the coach of the RV when the flushing of the toilet occurs. Also, when the orifices in the shower head used for flushing become clogged with sand and grit from the water sources at RV parks, the force might increase, however the benefit of the spray head is very inefficient at best. Only a small point of contact will be free of the solids when the spray is directed on the walls.

Also, improper monitoring of the process of flushing the tanks can allow hazardous material to overflow into the coach interior if the valves are not opened, or if the valves are not draining at the proper rate. Also, if the water level indicators that come with every RV fail, the only indication the black tank is full is by viewing the contents through the open commode.

It is well-known that human waste clumps when introduced to cold water. Human waste also sticks to the walls and can prevent an indicator light sensor (often used within RVs) from working. Fresh water will not properly clean the grease laden walls in the black tank.

The present method of emptying the tanks on RVs has several disadvantages. First, a hose 108 must be removed from storage dark and damp, and a perfect habitat for bacteria. A user must then connect the hose 108 to a single pipe 112 that connects the storage tanks, both gray and black water, through a Y pipe 116 controlled by manual valves (not shown). The user then places the hose 108 in a waste tank receptacle 120, and then opens the valves. The user will then empty the two tanks, including unbroken solids, via gravity-only. This requires that the RV 104 be parked and located in such a way that gravity-movement is facilitated, which can sometimes be inconvenient if not outright impossible.

After emptying, the user must remove and store the hose 108. During the emptying process, the user is exposed to splashes, spills and odors due to using gravity to empty the tanks through the large diameter 3″ hose 108. This large diameter is necessary to accommodate to allow clumps of human waste, toilet tissue and any other items that have been introduced into the commode, sinks, showers and laundry to flow out by gravity.

When the hose has finished emptying the tanks, the hose 108 is removed and prepared for storage. The water stored in the tanks is hazardous material to handle and risk to contamination and exposure to disease can result. Thus, rinsing is required to prepare the hose 108 for storage, which is impossible, even if a water hose supply is available. However, in many instances, fresh water is not available at public facilities.

Further, within many existing RV configurations, if the black or gray tanks become unusable due to clogged lines in the downstream or connecting plumbing, it is very difficult to remove the clogging material or the tanks if they are filled. When servicing the tanks or repairing the plumbing, the exposure to disease and harmful bacteria is high. Also, the conventional valves widely used within the RV industry (not shown) are inadequate to properly close the flow if solids or paper is allowed to stick in the sides of the gate valves. Thus, clogged lines and valves are very common in the RV industry.

To open the clogged lines, a flexible steel line must be rammed up the line and when this method is successful, the rushing sewage often moves faster than the user can get out of the way. In such a circumstance, the potential exposure to disease is significant.

The amount of clean treated water that is used to flush through the flush ports found on all black and grey tanks is typically much more than the amount of water that is flushed through the toilet. This is because most RV commodes are designed to empty with only a small amount of clean treated water.

However, despite this attempt at efficiency of use of water, in common practice an RV owner may use cleaning volumes that are equal to two and three times the capacity of a black or gray tank. This is an inefficient use of the drinking water supply which the present invention seeks to reduce.

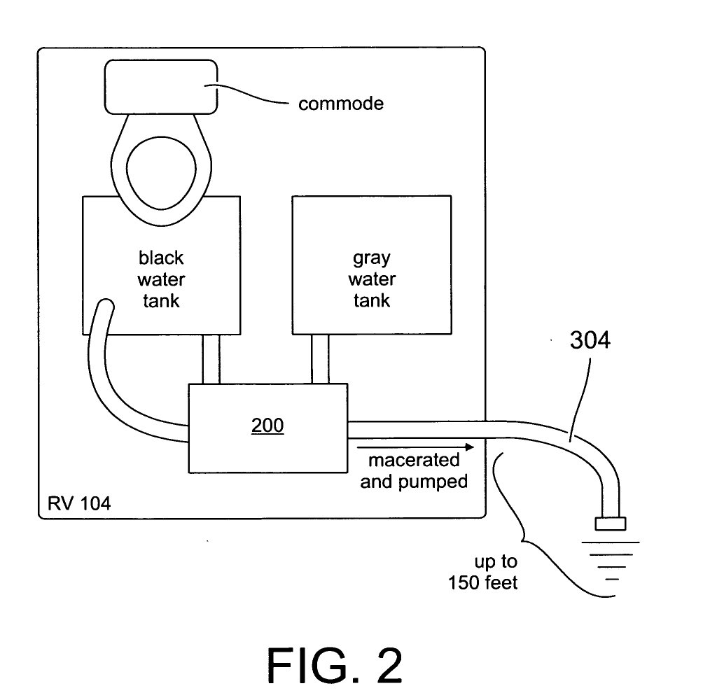

To address these concerns, FIG. 2 shows an exemplary embodiment of the present invention. As shown in FIG. 2, the present invention simplifies the plumbing situation present in typical RVs. From FIG. 1 it is apparent that, as stated, in a conventional RV, the distance between the black and gray tanks and the (downstream) discharge tube available to a user is lengthy. This is even more of a problem in larger RVs. Thus, a lot of clogs and jams can happen in the downstream plumbing, and occur in an area that is not readily user-accessible.

Meanwhile, FIG. 2 shows an RV 104 with the system 200 of the present invention implemented therein. From FIG. 2. it is apparent that the amount of downstream plumbing is reduced from FIG. 1. Reducing downstream plumbing from the tanks to the discharge tube and hose will make it easier to maintain and service the system. Also, service related technicians will be less exposed to the conditions presently involved in unclogging plumbing lines.

Within the existing RV universe, the purpose of the two tank (black and gray) holding tank system is designed partly for user convenience. Sanitation statutes regarding waste disposal allow a user to empty their gray water onto any ground surface, as long as it is not co-mingled with black water.

Accordingly, within the present invention, as shown in FIG. 2, gray water, though hazardous to handle, can be routed through the black tank at the user's choice using the system 200. This provides a secondary use of the contents of the gray tank, which otherwise has no value whatsoever.

Another problem solved by the present invention is that presently, gravity is necessary to empty both black and gray water tanks of a typical RV. Most RVs have gravity waste systems. However, RVs with gravity waste systems depend on public and private facilities to empty the tanks. The number of facilities available to the public is decreasing due to the high cost of maintenance and waste water treatment. This will cause an increase in the amount of sewage that is dumped onto public lands. Unfortunately, this eliminates the ability to empty these tanks anywhere except into receptacles that are lower than the opening of sewer pipe that exists underneath a typical RV. For example, the state of Illinois has a restriction that all receptacles at RV parks that are sited in a flood plain must be 18″ above the adjacent soil. This makes emptying the tanks by gravity impossible for most RVs.

The inadequate process of the gravity method of emptying the tanks is readily recognized due to the increase in demand for horse trailers that have sleeping quarters, fresh water storage and holding tanks for both black and gray water. The layout of the tanks and plumbing indicate additional problems as a result of the low frame height of a horse trailer, for example. Within a typical horse trailer, all of the water tanks, fresh, black, and gray are located in the space of the floor joist which is about 6″ ground clearance. Because of this low ground clearance, plumbing to control and permit the discharge of the tanks is easily knocked off or tom loose when the tow truck and the trailer span a higher obstacle.

Also, because of the minimal ground clearance, the assistance from gravity which is necessary to move the water and solids is minimal at best. Thus, the present method of storing and emptying the tanks is onerous and unsafe. It is not very predictable and introduces many different opportunities for mistakes and operator error.

The system 200 of the present invention addresses all of the above problems, and also eliminates most of the servicing problems associated with holding tanks. From FIG. 2 it is apparent that the discharge from the RV 104 is pumped and not merely drained by gravity.

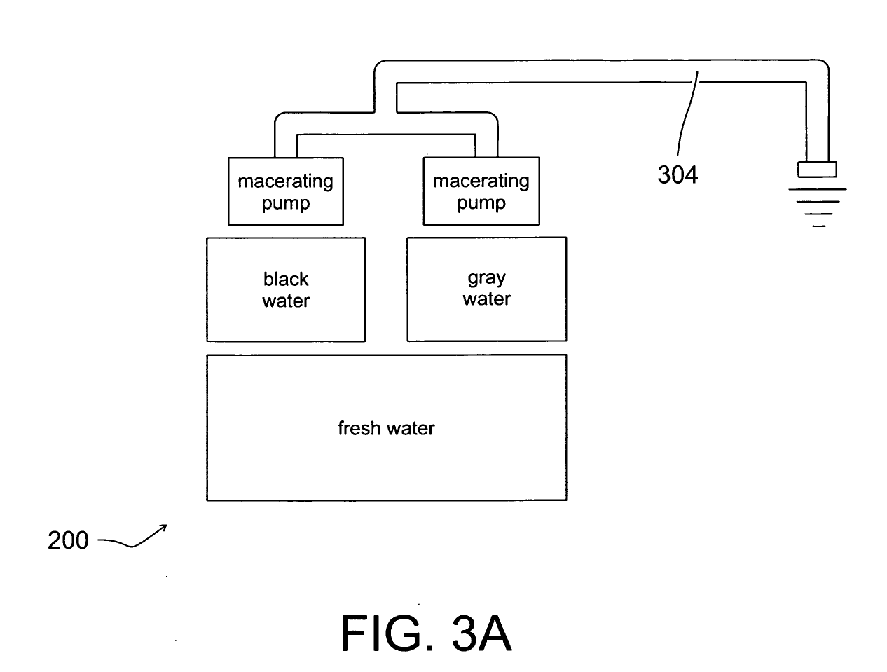

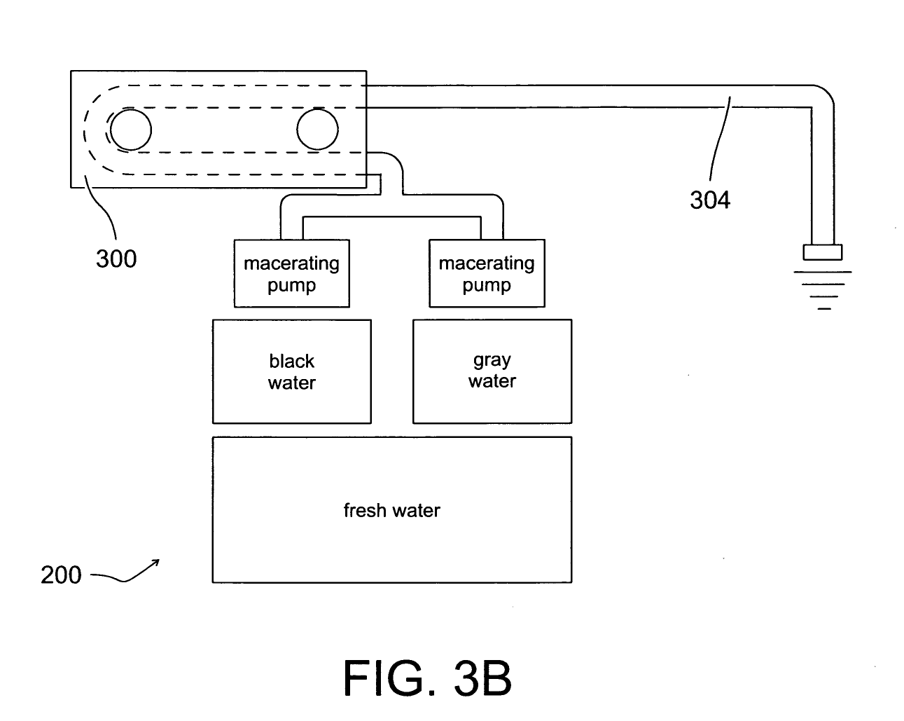

FIG. 3A shows one potential arrangement the system 200 of the present invention, which comprises black, gray, and fresh water tanks, along with macerating pumps attached to the black and gray tanks. FIG. 3B shows the system 200 of FIG. 3A further equipped with a housing 300, suitable for neatly and retractably storing the hose 304.

The embodiments shown in FIGS. 3A, 3B function as follows. When the various tanks need to be emptied, either black, gray, both, or gray into black, power is furnished to motors within the macerator-transfer pumps, so that a semi-liquid flow of content from whichever tank results. In the event of a requirement to remove and replace a macerator-transfer pump, a gate valve corresponding to that tank can be manually closed to eliminate any unexpected flow or volume. When the replacement of a macerator-transfer pump is completed, the gate valve or valves can be re-opened, and normal operation resumed.

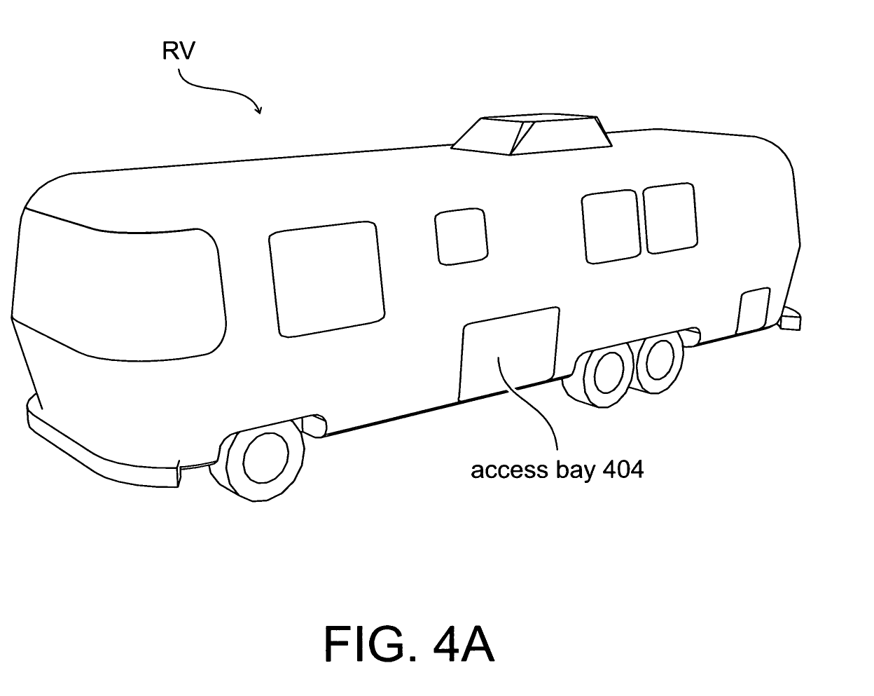

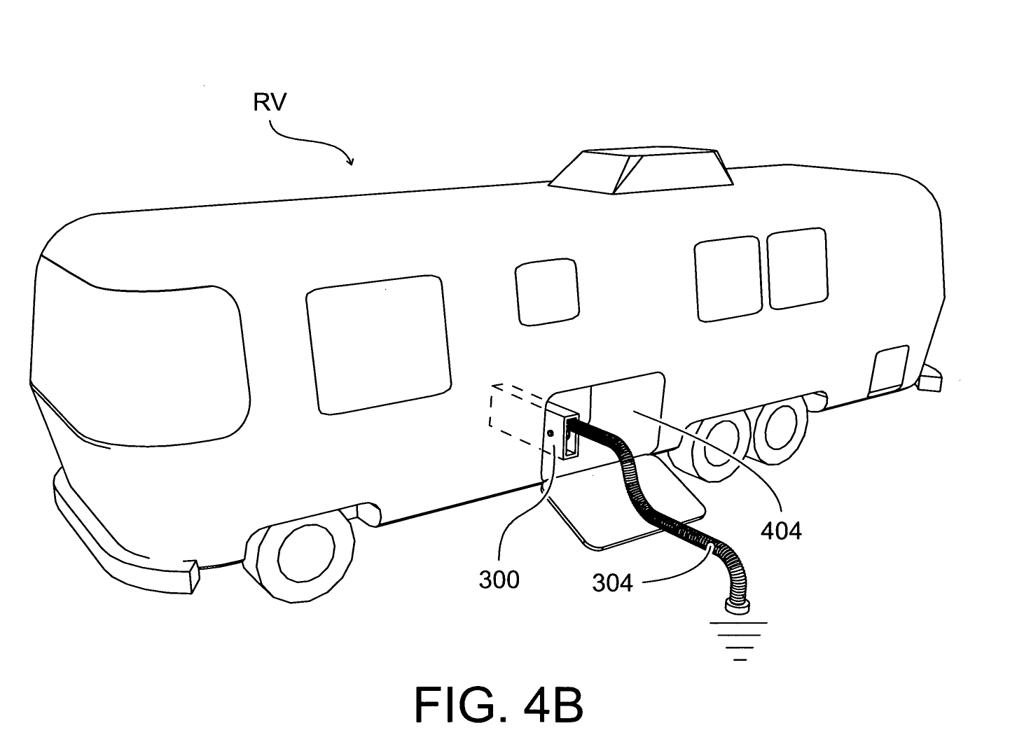

As shown in FIG. 4A, portions of the system 200 including but not limited to the macerating pumps, and the hose 304 are accessible through a covered service area 404 that is commonly found at the side of most RVs. One such possible repair would be to remove and unclog the pumps, in case some type of hardened plastic or metallic object got jammed therein. This accessibility would be useful in the event of a clogged pump would not require an RV user to cancel the trip and take apart the control system 200.

The water from the tanks is suctioned out of the tanks and passed through the macerator-transfer pumps. This step is taken so that the solid waste can be converted into a liquid stream by the macerator-transfer pumps and then introduced into a ¾″ or larger discharge hose. This is a significant improvement over the prior art, which required hoses having a minimum a 3″ diameter. Having smaller diameter hoses takes up significantly less space, and is also easier to maintain, clean, add attachments, and find spare parts.

As stated, FIG. 4A shows an RV with an access bay 404. FIG. 4B shows the embodiment of FIGS. 2 and 3 implemented within the RV of FIG. 4A. For clarity, certain portions of FIG. 4B are either deleted or exaggerated.

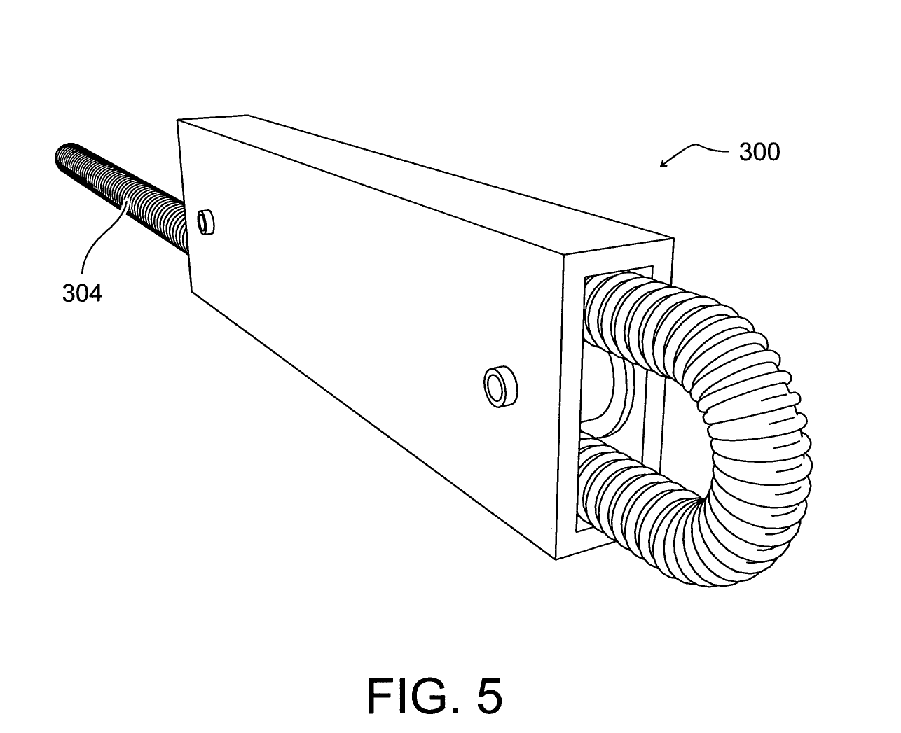

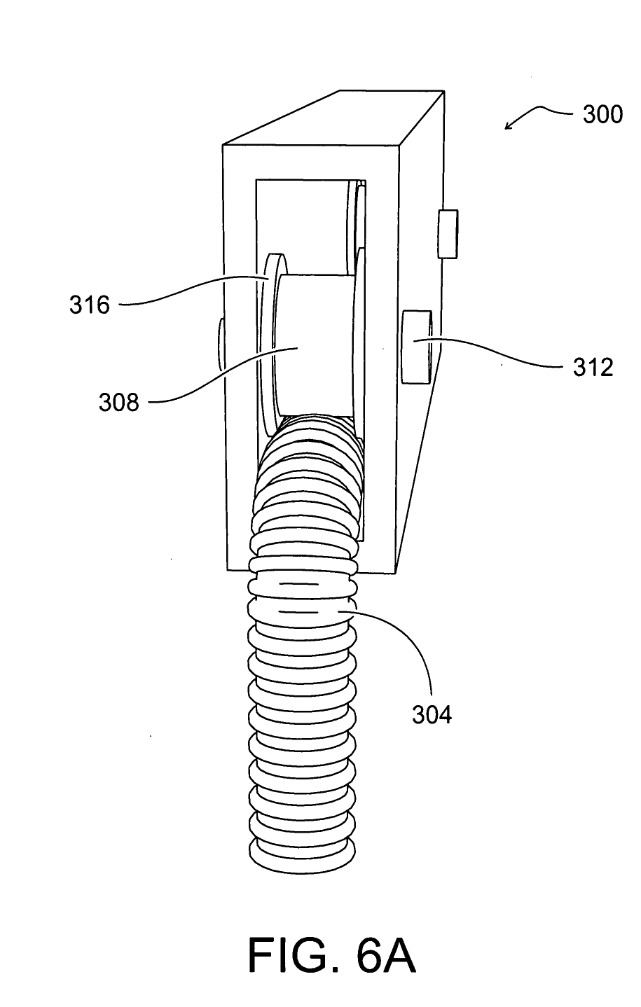

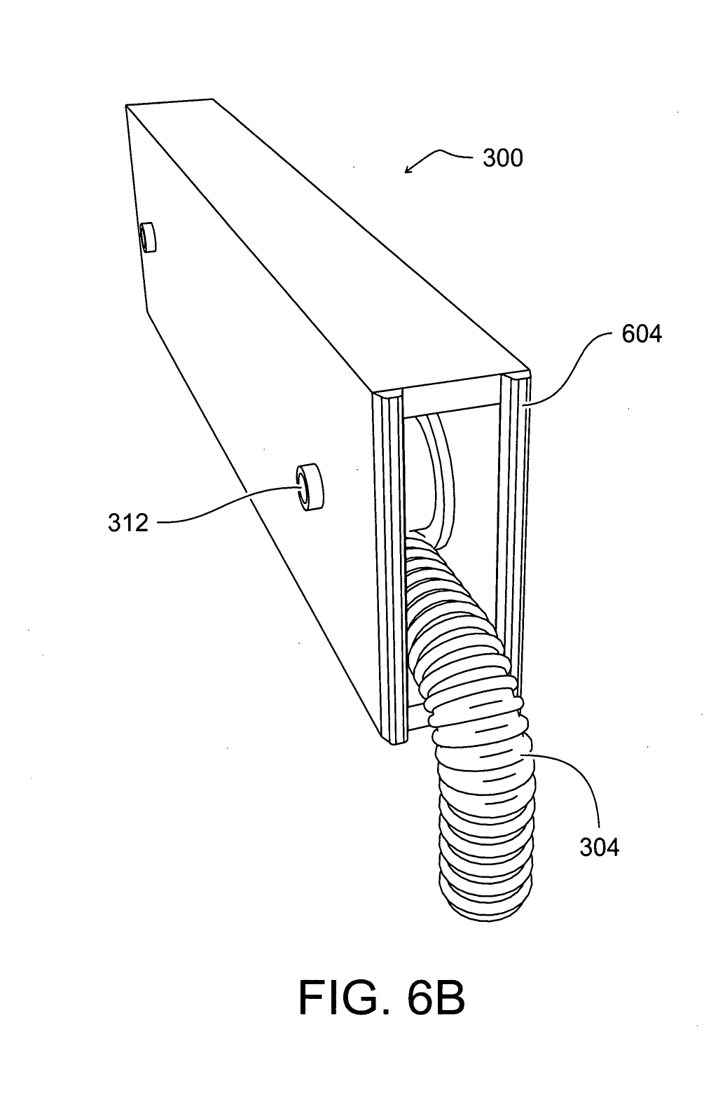

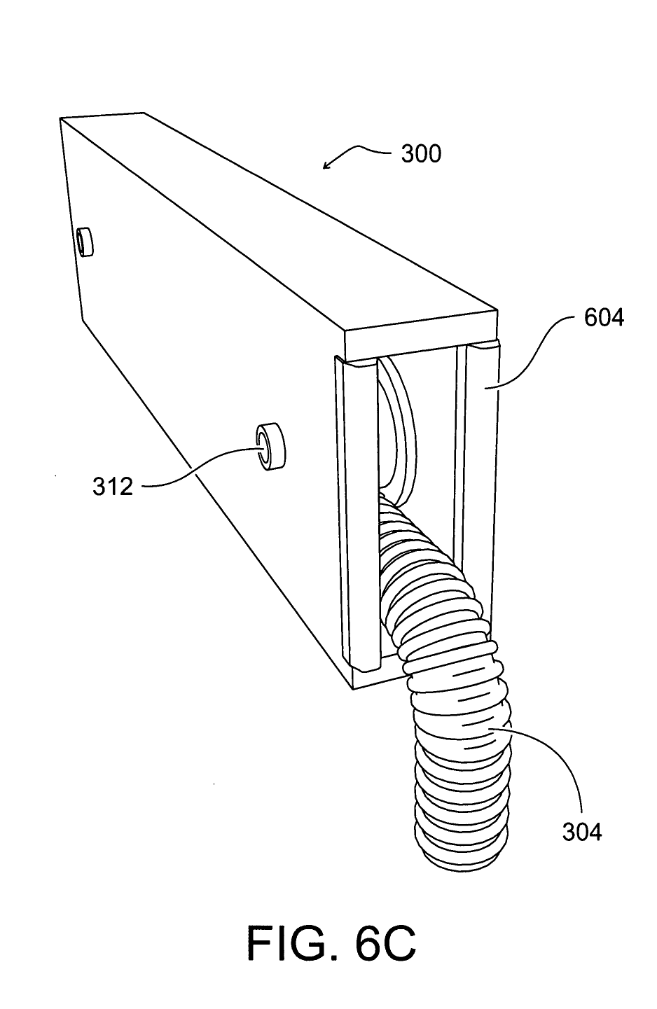

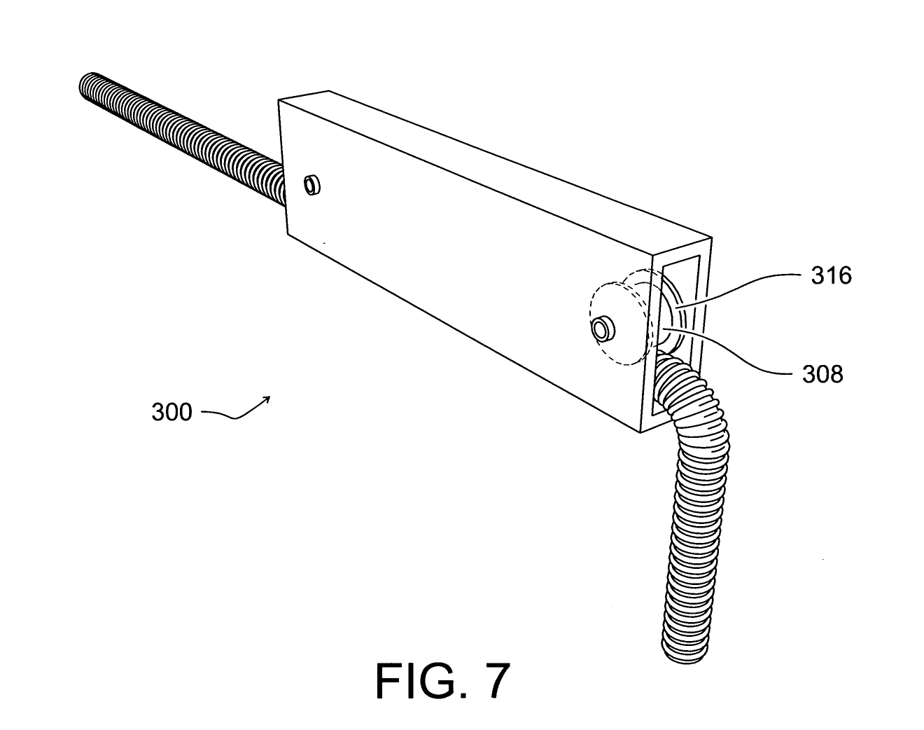

FIG. 5 shows an exemplary embodiment of the housing 300, with a hose 304 spooled therein. FIGS. 6A-6C and 7 shows more detail of the housing 300, including the spool 308 which rotates about an axle 312, and is equipped with symmetrical flanges 316. These flanges are useful for keeping the hose 304 properly aligned within the housing 300.

FIG. 6A shows a housing 300 with a hose 304 protruding therefrom. During use of the hose 304, it is possible that a user will twist or pull on the hose such that it is drawn against the edges of the housing 300. The corrugations within the hose 304 could conceivably get caught against the edges of the housing 300. If the user is not looking, and pulls harder against the hose 304, the increased force applied to the corrugations could result in the tearing of the hose 304.

To address this, FIG. 6B shows the housing 300 having a guard 604 positioned at the edges of the housing 300. The guard 604 can be manufactured within the housing 300, or can be added afterwards. The purpose of the guard 604 is to reduce the likelihood of tearing of the hose 304, by reducing the likelihood of a corner of the housing catching a corrugation within the hose 304.

FIG. 6C shows a variation of the guard 604, wherein the guard 604 is clipped to the housing 300 after its manufacture. The guard 604 of FIG. 6C acts to further reduce the likelihood of a corrugation of the hose 304 being caught against a corner or edge of the housing 300.

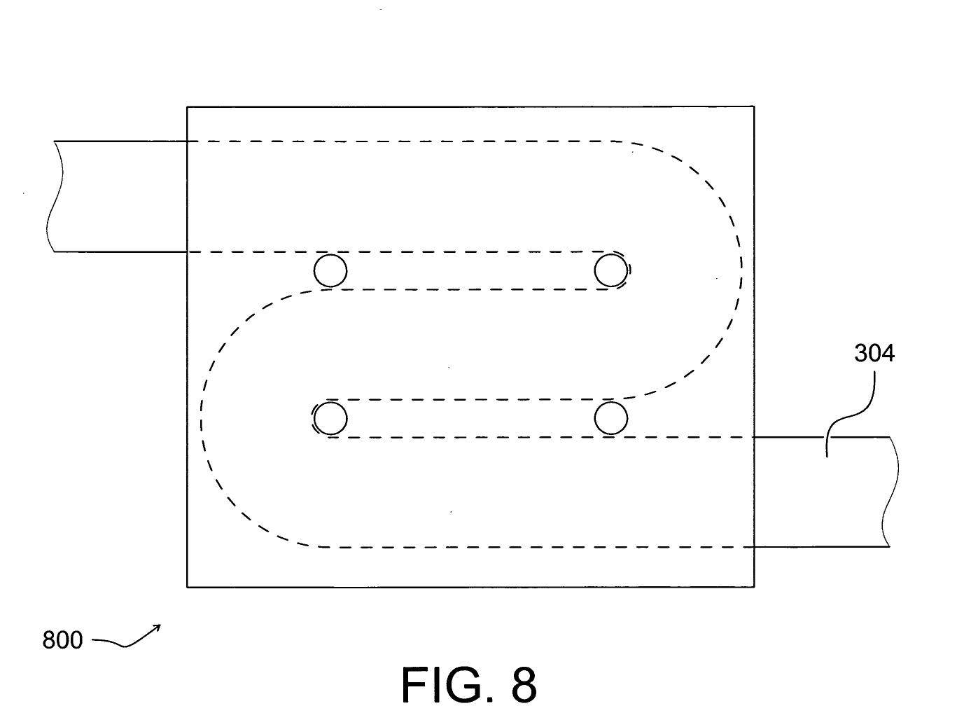

FIG. 8 shows another embodiment of the housing 800, in which multiple spools 308 are incorporated.

When emptying the tanks is completed, it becomes necessary to return the hose 304 to the housing 300, 800. To achieve this quickly and effectively, a user can attach a cap to the hose 304, thereby creating a mild pressure seal. The user can then reverse the polarity of the macerating pumps using a variety of user-input means. By reversing the polarity, the macerating pumps work in reverse, and attempt to pump any liquid remaining in the hose 304 back into the gray and black tanks (FIG. 4). However, there will be no liquid in the hose 304, and with the mild pressure-seal, the pumps will act to quickly withdraw the hose 304 back into the housing 300, 800, without the user having to feed the hose 304 or assist in any way.

The discharge hose 304 being connected to macerating pumps, thereby acting to transfer the contents of the tanks to a legal receptacle, either above or below the elevation of the discharge opening of the tanks. The nozzle on the end of the discharge hose flowing to the ground receptacle can be equipped with threads or couplings that will allow additional hoses to be installed. This is convenient because the discharge can then be conveyed great distances from the RV such as greater than 150 feet. Conversely, existing implementations of RVs require the RV to be pulled very close to the sewer tank input line.

Another advantage of the present invention is in its water conservation. Re-using the gray water to rinse and flush the black-water tank means that an RV can be parked in a single place for longer times. One example of this is an RV visiting a residential setting. Often, a guest visitor will park their RV at someone's driveway, and then sleep in the RV. They may also take a shower in the RV in the morning. However, that guest may also spend time with their host, go places together, plus be in the house together including using the commode in the house (rather than the commode in the RV). Under these circumstances, within the RV the gray water tank may fill at a significantly faster rate than the black water tank. Thus, the gray water tank may need emptying long before the black water tank. It is considered a discourtesy to empty a gray water tank into someone's driveway. Thus, having the ability to empty at least part of the gray water tank into the black water tank could mean that a person could stay longer in a driveway, without the need to move their RV.

Another advantage of the present invention is its convenient access. If it is necessary to make repairs to the macerating pumps, because the housing 300, 800 keeps the hose 304 neatly stored, these pumps are accessible to a user through the covered access bay 404 on the side of most RVs. Most advantageously, these pumps are accessible without having to remove any other parts.

The present invention will cause a beneficial change in the cost to build, operate, and maintain the tanks on an RV. It will also increase operator safety and water conservation. This is at least partly because the requirement for gravity is eliminated in the process of emptying the tanks on RV's, thereby increasing safe conveyance of hazardous materials to proper receptacles. Also, the operator will not be exposed to the waste discharge of the tanks.

The various aspects of the present invention has been described in detail with particular reference to preferred embodiments thereof, but it will be understood that variations and modifications can be effected within the spirit and scope of the invention as described herein. It is anticipated that various changes may be made in the arrangement and operation of the system of the present invention without departing from the spirit and scope of the invention, as depicted in the following claims.

What is claimed is:

1. A device for managing hoses within an access bay of a recreational vehicle, comprising:
a rectangular housing having an interior aperture,
a plurality of rotating spools located within the interior aperture;
an intake opening below one of the spools, for receiving and threading a flexible hose;
an output aperture above one of the spools, for providing user access to the flexible hose;
wherein the hose attaches to a plurality of macerator-transfer pumps which are in turn connected to black water and gray water tanks of the recreational vehicle.

2. The device of claim 1, further comprising:
the hose having corrugations.

3. The device of claim 1, further comprising:
the hose having a diameter of 0.75 inches.

4. The device of claim 1, wherein the housing further comprises means for retractably storing the hose.

5. The device of claim 1, wherein the plurality of rotating spools each comprise:
an axle, rotatably positioned within the interior aperture; and
symmetrical flanges, located at the outer edges of the spool nearest an interior wall of the housing, for keeping the hose properly aligned within the housing.

6. The device of claim 1, wherein the intake opening receives the hose automatically.

7. A device for controlling flow of wastewater within a recreational vehicle, comprising:
a plurality of macerator-transfer pumps under the control of the central controlling mechanism and connected to black water and gray water tanks of an RV;
a user-input mechanism for assisting a user in operating the central controlling mechanism;
a rectangular housing having an interior aperture, and a plurality of spools located within the interior aperture;
an intake opening below one of the spools, for receiving and threading a flexible hose;
an output aperture above one of the spools, for providing user access to the flexible hose;
wherein the flexible hose is connected to the central controlling mechanism.

8. The device of claim 7, further comprising:
the macerator-transfer pumps moves the contents of either of the gray and black tanks through the hose to an external drain.

9. The device of claim 7, further comprising:
the macerator-transfer pumps being capable of by-passing said black tank and pumping the contents of said gray directly through the hose to the exterior of the recreational vehicle.

10. The device of claim 7, further comprising:
the macerator-transfer pump moves the contents of the gray tank into the black tank.

11. The device of claim 7, further comprising:
the macerator-transfer pumps having the capacity to reverse polarity of the pumps to retract the hose.

12. The device of claim 7, further comprising:
the central controlling mechanism controls the direction the fluid is pumped through said macerator-transfer pump.

13. The device of claim 7, further comprising:
the user-input mechanism comprising a means of accepting user input and a series of indicator lights for indicating which functions have been accepted.

14. The device of claim 7, further comprising:
the user-input mechanism comprising a means retracting said hose for storage within said housing mechanism.

15. The device of claim 7, wherein the user-input mechanism further comprises a means of indicating the direction the content is being pumped through the macerator-transfer pumps.

16. The device of claim 7, wherein the user-input mechanism further comprises:
a plurality of indicator lights located on a front panel of the user-input mechanism, for indicating the functional status of the device.

17. The device of claim 16, wherein the indicator lights are arranged, sequenced, or blinked to indicate to a user that a specific event has occurred within the device.

18. The device of claim 16, wherein the indicator lights are arranged, sequenced, or blinked to indicate to a user that which tanks are currently being pumped.

19. The device of claim 16, wherein the indicator lights are blinked to indicate to a user the status of the operation of the macerator-transfer pumps.

20. The device of claim 16, wherein the central controlling mechanism further comprises:
means to force a shut-off of the plurality of macerator-transfer pumps and to alert a user of this event through the indicator lights.

21. The device of claim 7, wherein the central controlling mechanism further comprises:
means to reverse the pumps so as to retract the hose without a user touching the hose.

22. The device of claim 7, further comprising:
the spools operable by a user who pulls the hose through said output aperture.

23. A method of operating a system for emptying the tanks of a recreational vehicle, comprising:
opening a door of an service area on the recreational vehicle;
pulling a flexible hose from a spooled housing;
discharging contents of the tanks;
attaching a cap to the end of the hose, thereby;
creating a mild vacuum within the hose;
reversing the polarity of pumps used in the discharging step; and
automatically retracting the hose into the spooled housing.
